(19) United States
(12) Patent Application Publication
(10) Pub. No.: US 2025/0104401 A1
(43) Pub. Date: Mar. 27, 2025

(54) LEARNING DATA GENERATION APPARATUS, PRODUCT COUNT CONFIRMATION APPARATUS, LEARNING DATA GENERATION METHOD, PRODUCT COUNT CONFIRMATION METHOD, AND NON-TRANSITORY COMPUTER-READABLE STORAGE MEDIUM

(71) Applicant: NEC Corporation, Minato-ku, Tokyo (JP)

(72) Inventors: Soma SHIRAISHI, Tokyo (JP); Takami Sato, Tokyo (JP); Tomokazu Kaneko, Tokyo (JP)

(73) Assignee: NEC Corporation, Minato-ku, Tokyo (JP)

(21) Appl. No.: 18/730,381

(22) PCT Filed: Mar. 16, 2022
(86) PCT No.: PCT/JP2022/011897

§ 371 Date: Jul. 19, 2024

(51) Int. Cl. G06V 10/774; G06Q 20/20

(52) U.S. Cl. CPC G06V 10/774; G06Q 20/208

(57) ABSTRACT

A learning data generation apparatus includes an acquisition unit and a selection unit. The acquisition unit acquires a plurality of images generated by an image capture unit. The selection unit selects an image satisfying a predetermined condition out of the plurality of images acquired by the acquisition unit in order to include the image into at least part of learning data as negative data not including a target product. The number of products included in an image can be precisely detected by using a model generated by using the learning data.

### TECHNICAL FIELD

The present invention relates to a learning data generation apparatus, a product count confirmation apparatus, a learning data generation method, a product count confirmation method, and a storage medium.

### BACKGROUND ART

In recent years, when a customer purchases a product, the customer himself or herself may operate a product registration apparatus. In this case, the product may not be accurately registered. On the other hand, Patent Document 1 describes an information processing apparatus that performs the following processing. First, the information processing apparatus detects a product in a first predetermined area, such as a product in an area for placing an unregistered product. Next, the information processing apparatus decides whether the detected product moves to a second predetermined area, such as a product scanning area, within a predetermined time after moving out of the first predetermined area.

### RELATED DOCUMENT

### Patent Document

Patent Document 1: International Application Publication No. WO 2016/052229

### SUMMARY

### Technical Problem

As described above, when a customer himself or herself operates a product registration apparatus, a product may not be accurately registered. The technology described in Patent Document I can track only a product placed in the first predetermined area. Therefore, the possibility of degradation in precision of a registration result of a product in the product registration apparatus remains.

On the other hand, the present inventors have examined determination of existence of the possibility of inaccurate registration of a product by comparing the number of products registered by a product registration apparatus with the number of products included in a captured image of a region including the product registration apparatus. However, the number of products included in an image needs to be precisely detected when the processing is performed.

An example of an object of the present invention is to, in view of the problem described above, provide a learning data generation apparatus, a product count confirmation apparatus, a learning data generation method, a product count confirmation method, and a storage medium that, when the number of products is detected by processing an image, enable enhanced precision of the detection.

### Solution to Problem

An embodiment of the present invention provides a learning data generation apparatus that generates at least part of learning data for generating a model, in which
the model computes a number of one or more target products being targets of checkout and being included in an image generated by an image capture unit that has an image capture range including a region where the target products are placed,
the learning data generation apparatus including:
   an acquisition unit that acquires a plurality of images generated by the image capture unit; and
   a selection unit that selects an image satisfying one or more predetermined conditions out of the plurality of images in order to include the image into at least part of the learning data as negative data not including the target product.

Another embodiment of the present invention provides a product count confirmation apparatus used with the learning data generation apparatus described above, the product count confirmation apparatus including:
a computation unit that, by using the model generated by using the learning data, computes a first number being a number of the target products by processing the image captured by the image capture unit when a customer uses the product registration apparatus: and
an output unit that outputs predetermined information when a difference between a second number being a number of the target products registered in the product registration apparatus and the first number satisfies a criterion.

Still another embodiment of the present invention provides a learning data generation method performed by a computer that generates at least part of learning data for generating a model, in which
the model computes a number of one or more target products being targets of checkout and being included in an image generated by an image capture unit that has an image capture range including a region where the target products are placed,
the learning data generation method including, by the computer:
   acquiring a plurality of images generated by the image capture unit: and
   selecting an image satisfying one or more predetermined conditions out of the plurality of images in order to include the image into at least part of the learning data as negative data not including the target product.

Still another embodiment of the present invention provides a product count confirmation method including, by a computer used with the learning data generation apparatus described above:
by using the model generated by using the learning data, computing a first number being a number of the target products by processing the image captured by the image capture unit when a customer uses the product registration apparatus: and
outputting predetermined information when a difference between a second number being a number of the target products registered in the product registration apparatus and the first number satisfies a criterion.

Still another embodiment of the present invention provides a storage medium on which a program causing a computer to generate at least part of learning data for generating a model is recorded, in which
the model computes a number of one or more target products being targets of checkout and being included in an image generated by an image capture unit that has an image capture range including a region where the target products are placed,
the program causing the computer to execute:
   an acquisition function of acquiring a plurality of images generated by the image capture unit: and
   a selection function of selecting an image satisfying one or more predetermined conditions out of the plurality of images in order to include the image into at least part of the learning data as negative data not including the target product.

Still another embodiment of the present invention provides a storage medium on which a program used by a computer used with the learning data generation apparatus described above is recorded, the program causing the computer to execute:
a computation function of, by using the model generated by using the learning data, computing a first number being a number of the target products by processing the image captured by the image capture unit when a customer uses the product registration apparatus: and
an output function of outputting predetermined information when a difference between a second number being a number of the target products registered in the product registration apparatus and the first number satisfies a criterion.

### Advantageous Effects of Invention

The embodiments of the present invention can provide a learning data generation apparatus, a product count confirmation apparatus, a learning data generation method, a product count confirmation method, and a storage medium that, when the number of products is detected by processing an image, enable enhanced precision of the detection.

### BRIEF DESCRIPTION OF DRAWINGS

FIG. 1 It is a diagram illustrating an overview of a learning data generation apparatus according to an example embodiment.

FIG. 2 It is a diagram illustrating an overview of a product count confirmation apparatus according to the example embodiment.

FIG. 3 It is a diagram for illustrating a use environment of the learning data generation apparatus and the product count confirmation apparatus.

FIG. 4 It is a diagram illustrating an example of a placement of the product count confirmation apparatus.

FIG. 5 It is a diagram illustrating an example of a functional configuration of the learning data generation apparatus.

FIG. 6 It is a diagram for illustrating an example of a region on which object detection processing is to be performed by an image processing unit.

FIG. 7 It is a diagram illustrating an example of learning data stored in a learning data storage unit.

FIG. 8 It is a diagram illustrating an example of a functional configuration of the product count confirmation apparatus.

FIG. 9 It is a diagram illustrating a hardware configuration example of the learning data generation apparatus.

FIG. 10 It is a flowchart illustrating an example of processing performed by the learning data generation apparatus.

FIG. 11 It is a flowchart illustrating an example of processing performed by the product count confirmation apparatus.

FIG. 12 It is a diagram illustrating a modified example of FIG. 4.

### EXAMPLE EMBODIMENTS

Example embodiments of the present invention will be described below by using drawings. Note that in every drawing, similar components are given similar signs, and description thereof is will not be repeated as appropriate.

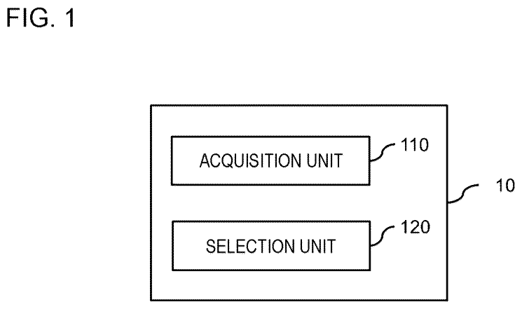

FIG. 1 is a diagram illustrating an overview of a learning data generation apparatus 10 according to an example embodiment. The learning data generation apparatus 10 generates at least part of learning data for generating a model. The model computes the number of target products included in an image generated by an image capture apparatus. A target product is a product being a target of checkout. An image capture range of the image capture apparatus includes a region in which target products are placed.

The learning data generation apparatus 10 includes an acquisition unit 110 and a selection unit 120. The acquisition unit 110 acquires a plurality of images generated by an image capture unit. The selection unit 120 selects an image satisfying a predetermined condition out of the plurality of images acquired by the acquisition unit 110 in order to include the image into at least part of learning data as negative data not including a target product.

The learning data generation apparatus 10 causes an image satisfying the predetermined condition to be included in learning data as negative data not including a target product. Therefore, a model generated by using the learning data allows the number of products included in an image to be precisely detected.

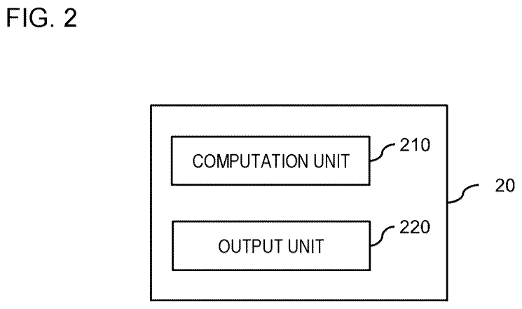

FIG. 2 is a diagram illustrating an overview of a product count confirmation apparatus 20 according to the example embodiment. The product count confirmation apparatus 20 is used with the learning data generation apparatus 10 and includes a computation unit 210 and an output unit 220. By using a model generated by using learning data generated by the learning data generation apparatus 10, the computation unit 210 computes a first number being the number of target products by processing an image captured by the image capture apparatus when a customer uses a product registration apparatus. The output unit 220 outputs predetermined information when the difference between a second number being the number of target products registered in the product registration apparatus and the first number satisfies a criterion.

The detection precision of the first number by the product count confirmation apparatus 20 is high. Further, the product count confirmation apparatus 20 performs predetermined output when the difference between the number of target products included in an image and the number of target products registered in the product registration apparatus does not satisfy the criterion. Therefore, an administrator or a customer of the product count confirmation apparatus 20 can recognize that a product may not be accurately registered.

Detailed examples of the learning data generation apparatus 10 and the product count confirmation apparatus 20 will be described below.

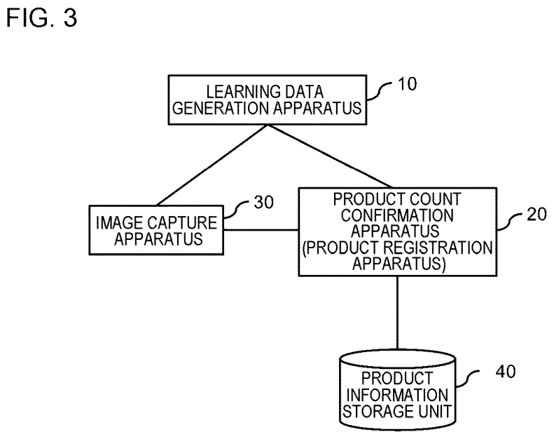

FIG. 3 is a diagram for illustrating a use environment of the learning data generation apparatus 10 and the product count confirmation apparatus 20. In an example illustrated in the diagram, the product count confirmation apparatus 20 also serves as a product registration apparatus. Then, the learning data generation apparatus 10 and the product count confirmation apparatus 20 are used with an image capture apparatus 30 and a product information storage unit 40.

The product count confirmation apparatus 20 is installed in a store or an office. Products are placed in the store or the office. The product count confirmation apparatus 20 registers a product to be purchased by a customer and performs checkout processing of the registered product. In other words, the product count confirmation apparatus 20 also functions as a product registration apparatus and a checkout apparatus. The product count confirmation apparatus 20 may be a POS terminal. The product count confirmation apparatus 20 is operated by a customer in registration processing and checkout processing of a target product. Further, the product count confirmation apparatus 20 uses the product information storage unit 40 in the registration processing and the checkout processing of a target product.

Note that the product count confirmation apparatus 20 may not perform the registration processing and the checkout processing of a target product. In this case, the product count confirmation apparatus 20 is an apparatus separate from a POS terminal, such as a cloud server.

The product information storage unit 40 stores information required for the checkout processing of a product, such as the price of the product, in association with product identification information of the product. For example, the product information storage unit 40 is part of a server installed in a store but is not limited thereto.

The image capture apparatus 30 operates at least while the product count confirmation apparatus 20 is turned on. The image capture apparatus 30 may operate 24 hours a day. Further, the image capture apparatus 30 may generate an image including RGB data for each pixel or may generate an image including depth information for each pixel. The image capture apparatus 30 regularly generates an image. The images may constitute a dynamic image. For example, a frame rate of the image capture apparatus 30 is equal to or greater than 0.1 fps and equal to or less than 30 fps but is not limited thereto.

The image capture apparatus 30 may be mounted at any position. The image capture apparatus 30 may be mounted above the product count confirmation apparatus 20, for example, on the ceiling of a room where the product count confirmation apparatus 20 is placed or may be mounted on the product count confirmation apparatus 20.

The image capture range of the image capture apparatus 30 includes a region where a target product is placed when the registration processing of the target product is performed. The region where a target product is placed includes at least one of a region where a target product is temporarily placed and a region where a target product is placed when product identification information of the target product is registered in the product count confirmation apparatus 20. An example of the former is a region where a target product is temporarily placed on a table 50. An example of the latter is a region (a space) where ancillary equipment 60 that reads product identification information from a target product can read the product identification information.

Note that the image capture range of the image capture apparatus 30 may further include the product count confirmation apparatus 20 and a product display region. A product that can be registered in the product count confirmation apparatus 20 may be placed only in a product display region included in the image capture range or may be placed in a product display region out of the image capture range.

By using an image generated by the image capture apparatus 30, the learning data generation apparatus 10 generates learning data for generating a model. The model is used for computing the number of target products positioned in the image capture range. The learning data generation apparatus adds an image satisfying a predetermined condition out of images generated by the image capture apparatus 30 to the learning data as negative data not including a target product.

Note that in the example illustrated in the diagram, the learning data generation apparatus 10 also generates the model described above. However, the model generation processing may be performed by an apparatus different from the learning data generation apparatus 10.

The product count confirmation apparatus 20 computes the number of target products positioned in the image capture range, that is, a first number by processing an image captured by the image capture apparatus 30. At this time, the product count confirmation apparatus 20 uses a model generated by the learning data generation apparatus 10. Then, the product count confirmation apparatus 20 performs the predetermined output when the difference between the first number and the number of target products registered in the product count confirmation apparatus 20, that is, a second number satisfies the criterion.

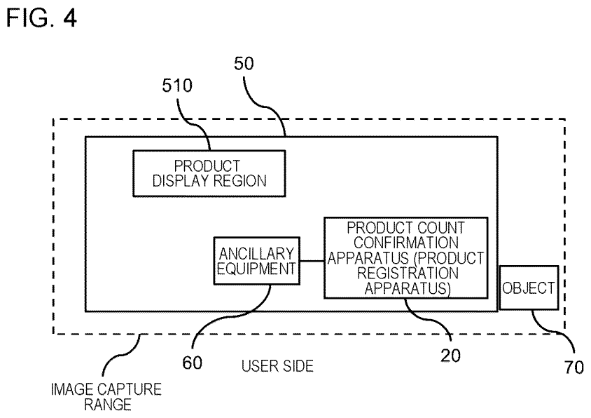

FIG. 4 is a diagram illustrating an example of a placement of the product count confirmation apparatus 20. The product count confirmation apparatus 20 is placed on the table 50. The table 50 is sufficiently larger than the product count confirmation apparatus 20 and part of the table 50 is a product display region 510. In the example illustrated in the diagram, the image capture range of the image capture apparatus 30 includes the product count confirmation apparatus 20 and the product display region 510. Note that as described by using FIG. 3, a target product that may be registered into the product count confirmation apparatus 20 may be displayed at a location other than the product display region 510.

Ancillary equipment 60 of the product count confirmation apparatus 20, such as at least one of a card reader, a barcode reader, a two-dimensional code reader, a short-distance wireless communication apparatus that communicates with a wireless communication tag mounted on a product, a short-distance wireless communication apparatus that communicates with a mobile terminal, and a receipt printer, is often placed on the table 50. Further, an object 70, such as a trash can, may be placed around the table 50. When the image capture range includes the ancillary equipment 60 and an object 70, the ancillary equipment 60 and the object 70 may be falsely recognized as target products.

Negative data described above are used for preventing the equipment and the object from being falsely recognized as target products.

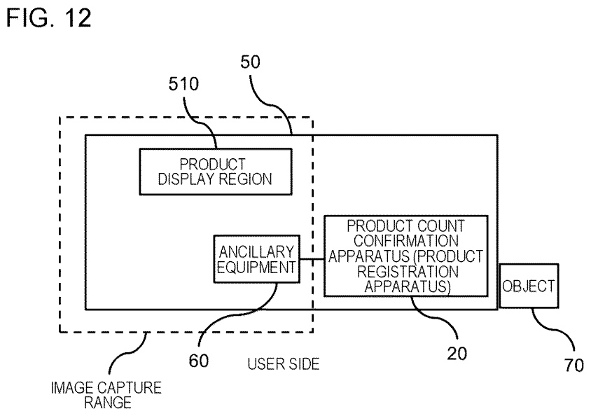

FIG. 12 is a diagram illustrating a modified example of the image capture range of the image capture apparatus 30. In the example illustrated in the diagram, the image capture range includes the product display region 510 and the ancillary equipment 60 but does not include the product count confirmation apparatus 20. Thus, the image capture range of the image capture apparatus 30 has only to include a region where a target product is placed.

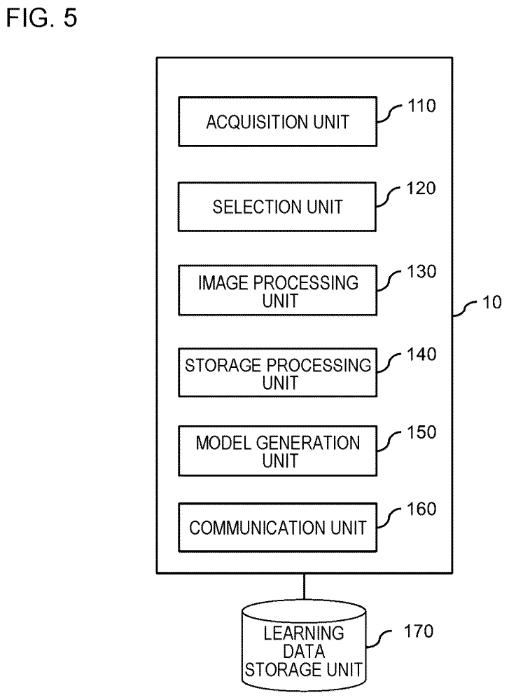

FIG. 5 is a diagram illustrating an example of a functional configuration of the learning data generation apparatus 10. The learning data generation apparatus 10 includes the acquisition unit 110, the selection unit 120, an image processing unit 130, a storage processing unit 140, a model generation unit 150, and a communication unit 160. The learning data generation apparatus 10 may use a learning data storage unit 170.

The acquisition unit 110 acquires a plurality of images generated by the image capture apparatus 30. For example, the acquisition unit 110 acquires the images from the image capture apparatus 30 but may acquire the images from a storage apparatus storing the images. The acquisition unit 110 may acquire all the images generated by the image capture apparatus 30 or may acquire only part of the images. Further, when acquiring images, the acquisition unit 110 also acquires image capture date and time data of the images.

Note that the acquisition unit 110 may store a plurality of acquired images into a storage unit such as the learning data storage unit 170.

The selection unit 120 selects an image satisfying a predetermined condition out of a plurality of images acquired by the acquisition unit 110 as negative data not including a target product and stores the image into the learning data storage unit 170 as at least part of learning data. At this time, the selection unit 120 uses image capture date and time data of each image as needed. For example, the predetermined condition is a condition indicating that the possibility of the product count confirmation apparatus 20 not being used is high.

Examples of the predetermined condition include at least one of the following items (1) to (5).
(1) The difference between the image and a reference image satisfies a first criterion.

For example, the reference image is a preset background image or an image generated prior to the image by a predetermined time (or by a predetermined number of images) out of images generated by the image capture apparatus 30. Further, an example of the first criterion is that the difference is equal to or less than a reference value. There is no object moving around the product count confirmation apparatus 20 when the condition is satisfied, and therefore, the product count confirmation apparatus 20 is highly likely not used.
(2) The state of the product count confirmation apparatus 20 satisfies a second criterion at a generation timing of the image.

In this case, for each date and time, the acquisition unit 110 acquires information indicating the state of the product count confirmation apparatus 20, that is, information indicating changes in the state from the product count confirmation apparatus 20 or an apparatus managing the product count confirmation apparatus 20. The selection unit 120 uses the information.

Further, the second criterion is a state indicating that the product count confirmation apparatus 20 is not used. Examples of the second criterion are as follows.
The product count confirmation apparatus 20 is not performing the registration processing of a product.
The product count confirmation apparatus 20 is in the standby mode and is turned off.
(3) The generation timing of the image is a predetermined date and time.

The predetermined date and time is a date and time when a store is closed or an office is closed, or a date and time when the product count confirmation apparatus 20 is not used in an operation plan of the product count confirmation apparatus 20. Note that a date and time herein may also refer to a time period for each date or each day of the week.
(4) The image includes a specific object.

The specific object is an object indicating that the product count confirmation apparatus 20 cannot be used, such as a signboard. In this case, the selection unit 120 previously stores a feature value of the object. Then, the selection unit 120 determines existence of an object having the feature value by performing image processing.
(5) No person exists in a predetermined region at the generation timing of the image.

The predetermined region is a specific region in a store or an office. The region may or may not include the image capture range of the image capture apparatus 30. In the latter case, the predetermined region may include a region around the image capture range of the product count confirmation apparatus 20, such as a passage toward the product count confirmation apparatus 20. Examples of processing to be performed include the following items (5-1) to (5-3).
(5-1) The selection unit 120 performs human detection processing on an image acquired by the acquisition unit 110 and sets an image in which a person cannot be detected to negative data.
(5-2) The selection unit 120 acquires an image from an image capture apparatus for surveillance placed in a store or an office and performs human detection processing on the image. Then, the selection unit 120 determines a timing at which no person exists in a predetermined region and sets an image generated by the image capture apparatus 30 at the timing to negative data.
(5-3) By using a detection result of a human sensor having a predetermined region as a detection range, the selection unit 120 determines a timing at which no person exists in the predetermined region. For example, the human sensor is an infrared sensor. Then, the product count confirmation apparatus 20 sets an image generated by the image capture apparatus 30 at the timing to negative data.

The image processing unit 130 performs object detection processing on an image selected by the selection unit 120, that is, an image being negative data. An algorithm of the object detection processing performed here is preferably the same as an algorithm used by the product count confirmation apparatus 20 for computing a first number, such as a model used by the product count confirmation apparatus 20.

The storage processing unit 140 stores each of a plurality of images selected by the product count confirmation apparatus 20 into the learning data storage unit 170 as learning data. At this time, the plurality of images are stored into the learning data storage unit 170 as negative data. Specifically, the storage processing unit 140 stores each of the plurality of images tied to a processing result of the image by the image processing unit 130 into the learning data storage unit 170.

The negative data stored in the learning data storage unit 170 include an image and data indicating that the image does not include a product. An example of data indicating that a product is not included is “data indicated by a product position do not exist.” On the other hand, positive data including an image including a product include the image and data indicating the position of the product in the image. The learning data storage unit 170 preferably also includes the positive data.

The model generation unit 150 generates or updates a model by using learning data stored in the learning data storage unit 170. An example of processing performed here is as follows.

First, the model generation unit 150 performs the object detection processing on the learning data with the current model. A value indicating a likelihood of being an object is generated in each image for each part of the image by the processing. Then, for a region (positive) in which an object to be detected exists, the model generation unit 150 adjusts a parameter of the model in such a way that the value indicating a likelihood of being an object increases. On the other hand, for a region (negative) in which an object to be detected does not exist, the model generation unit 150 adjusts the parameter of the model in such a way that the aforementioned value indicating a likelihood of being an object decreases.

In the processing, the model generation unit 150 may use only negative data described above as learning data or may include positive data including a product. In negative data, an explanatory variable is at least one item out of an image and data acquired by processing the image (such as an object detection result by the image processing unit 130), and a response variable is 0. On the other hand, in positive data, an explanatory variable is at least one item out of an image and data acquired by processing the image, and a response variable is the number of products included in the image. The model generation unit 150 stores the generated or updated model into the learning data storage unit 170.

The communication unit 160 transmits a model generated or updated by the model generation unit 150 to the product count confirmation apparatus 20.

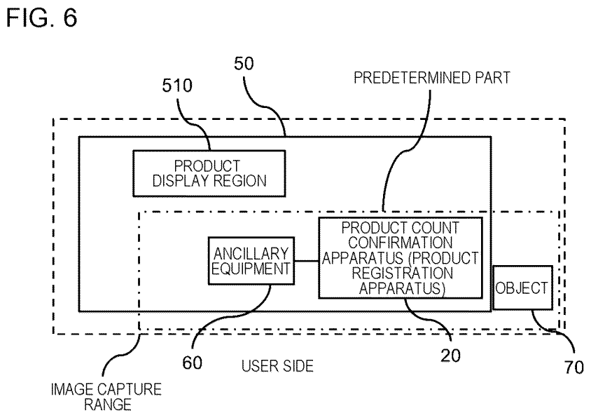

FIG. 6 is a diagram for illustrating an example of a region on which the object detection processing is to be performed by the image processing unit 130. The processing by the image processing unit 130 may be performed on a predetermined part out of an image on which the processing is to be performed. For example, in the processing of computing a first number, the product count confirmation apparatus 20 may perform detection processing of a product only on a specific part of an image generated by the image capture apparatus 30. In this case, the image processing unit 130 may perform the object detection processing only on the specific part.

For example, the predetermined part is set in such a way as not to include the product display region 510 and to include the ancillary equipment 60. As an example, the predetermined part includes a region where a product is placed when the ancillary equipment 60 as a code reader reads the code of the product. Further, the predetermined part may be set to further include an object 70.

Note that there are two types of method for specifying the predetermined part, one being specifying the part and the other being specifying a region other than the part.

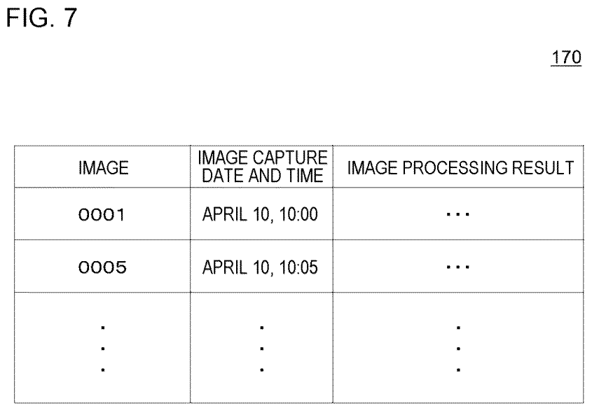

FIG. 7 is a diagram illustrating an example of learning data stored in the learning data storage unit 170. In the example illustrated in the diagram, the learning data storage unit 170 stores each of a plurality of images tied to image capture date and time data of the image and data indicating a result of object detection by the image processing unit 130.

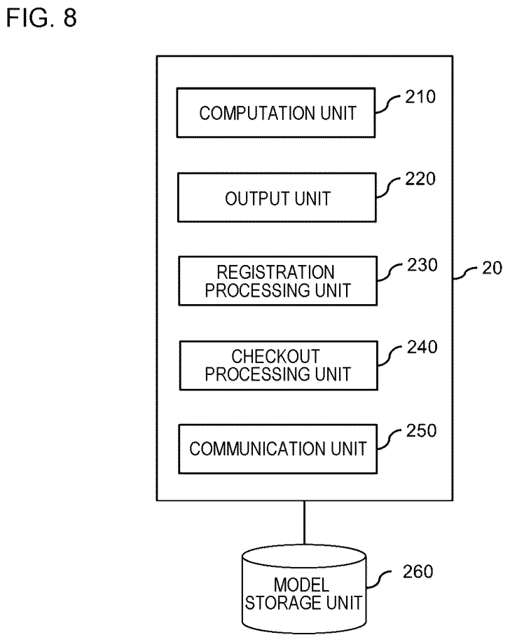

FIG. 8 is a diagram illustrating an example of a functional configuration of the product count confirmation apparatus 20. The product count confirmation apparatus 20 can use a model storage unit 260. The model storage unit 260 stores a model generated by the model generation unit 150 in the learning data generation apparatus 10. The model storage unit 260 may be external to the product count confirmation apparatus 20 or may be part of the product count confirmation apparatus 20.

Then, the product count confirmation apparatus 20 includes the computation unit 210, the output unit 220, a registration processing unit 230, a checkout processing unit 240, and a communication unit 250.

The communication unit 250 acquires a model by communicating with the learning data generation apparatus 10. Then, the communication unit 250 stores the acquired model into the model storage unit 260.

For example, the registration processing unit 230 performs the registration processing of a product being a checkout target, that is, a target product by using a readout result by the ancillary equipment 60. For example, the ancillary equipment 60 reads a code assigned to a target product. The code includes product identification information. The registration processing unit 230 performs the registration processing of the target product by using the code read by the ancillary equipment 60. Registration information generated as a result of the registration processing includes at least one piece of product identification information.

By using registration information generated by the registration processing unit 230 and information stored in the product information storage unit 40, the checkout processing unit 240 computes an amount to be paid by a customer. Then, the checkout processing unit 240 performs the checkout processing for the amount. At this time, the checkout processing unit 240 uses a readout result of a card or a mobile terminal by the ancillary equipment 60 for determining a payment method. The payment method used here is an electronic payment and for example, is at least one method out of payment using a credit card, payment using electronic money, and payment using a two-dimensional code.

By using a model stored in the model storage unit 260, the computation unit 210 computes a first number by processing an image generated by the image capture apparatus 30 when a customer uses the product count confirmation apparatus 20. The image used here may be a dynamic image, that is, a plurality of frame images indicating an operation of the customer during the registration processing of a target product. Note that the computed first number is equivalent to the number of target products to be purchased by the customer.

For example, an image being a processing target by the computation unit 210 includes an image generated during operation of the registration processing unit 230. At the timing when the image is generated, a target product may be placed on the table 50 or may be held by a customer. The image being a processing target by the computation unit 210 may further include an image generated within a predetermined time prior to operation of the registration processing unit 230. For example, the predetermined time is selected from a range of equal to or greater than 1 second and equal to or less than 30 seconds, and preferably a range of equal to or greater than 5 seconds and equal to or less than 15 seconds.

By using registration information generated by the registration processing unit 230, the output unit 220 computes the number of target products registered in the product count confirmation apparatus 20, that is, a second number. Then, the output unit 220 outputs predetermined information when the difference between the second number and the first number satisfies a criterion. The criterial number may be 1, or 2 or greater. The predetermined information output by the output unit 220 indicates the possibility of a registration result of a product in the product count confirmation apparatus 20 being incorrect and for example, is displayed on a display of the product count confirmation apparatus 20. At this time, the output unit 220 may output a predetermined voice from a speaker in the product count confirmation apparatus 20. A customer operating the product count confirmation apparatus 20 can recognize the possibility of a registration result of a product in the product count confirmation apparatus 20 being incorrect by recognizing the output by the output unit 220.

Note that when the product count confirmation apparatus 20 is used as an apparatus separate from a POS terminal, such as a cloud server, the product count confirmation apparatus 20 does not include the registration processing unit 230 and the checkout processing unit 240. In this case, a terminal including the registration processing unit 230 and the checkout processing unit 240, such as a POS terminal, is placed, for example, at the position of the product count confirmation apparatus 20 in FIG. 5 separately from the product count confirmation apparatus 20. Then, the output unit 220 in the product count confirmation apparatus 20 transmits information indicating whether the difference between the second number and the first number satisfies the criterion to the terminal. The terminal causes the display of the terminal to display the predetermined information or causes a speaker in the terminal to output the predetermined information when the difference between the second number and the first number satisfies the criterion.

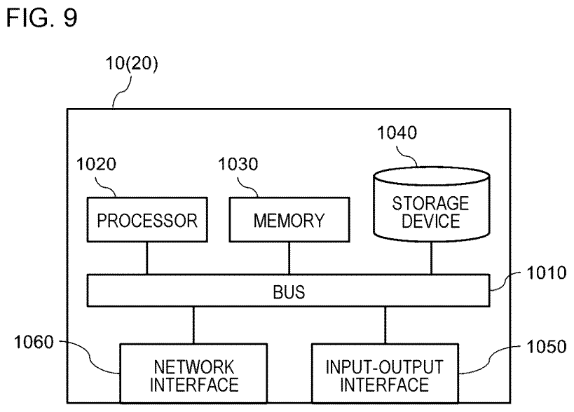

FIG. 9 is a diagram illustrating a hardware configuration example of the learning data generation apparatus 10. The learning data generation apparatus 10 includes a bus 1010, a processor 1020, a memory 1030, a storage device 1040, an input-output interface 1050, and a network interface 1060. The bus 1010 is a data transmission channel for the processor 1020, the memory 1030, the storage device 1040, the input-output interface 1050, and the network interface 1060 to transmit and receive data to and from each other. Note that the method for connecting the processor 1020 and other components is not limited to a bus connection.

The processor 1020 is a processor provided by a central processing unit (CPU), a graphics processing unit (GPU), or the like.

The memory 1030 is a main storage provided by a random-access memory (RAM) or the like.

The storage device 1040 is an auxiliary storage provided by a removable medium such as a hard disk drive (HDD), a solid-state drive (SSD), or a memory card, a read-only memory (ROM), or the like and includes a storage medium. The storage medium in the storage device 1040 stores program modules for providing the functions of the learning data generation apparatus 10 (such as the acquisition unit 110, the selection unit 120, the image processing unit 130, the storage processing unit 140, the model generation unit 150, and the communication unit 160). By reading each program module into the memory 1030 and executing the program module by the processor 1020, each function related to the program module is provided. Further, the storage device 1040 may function as the learning data storage unit 170.

The input-output interface 1050 is an interface for connecting the learning data generation apparatus 10 to various types of input/output equipment.

The network interface 1060 is an interface for connecting the learning data generation apparatus 10 to a network. Examples of the network include a local area network (LAN) and a wide area network (WAN). The method for connecting the network interface 1060 to the network may be a wireless connection or a wired connection. The learning data generation apparatus 10 may communicate with the product count confirmation apparatus 20 and the image capture apparatus 30 through the network interface 1060.

Note that a hardware configuration of the product count confirmation apparatus 20 is similar to the hardware configuration of the learning data generation apparatus 10 illustrated in FIG. 9. Then, the storage medium in the storage device 1040 stores program modules for providing the functions of the product count confirmation apparatus 20 (such as the computation unit 210, the output unit 220, the registration processing unit 230, the checkout processing unit 240, and the communication unit 250). The storage device 1040 may function as the model storage unit 260.

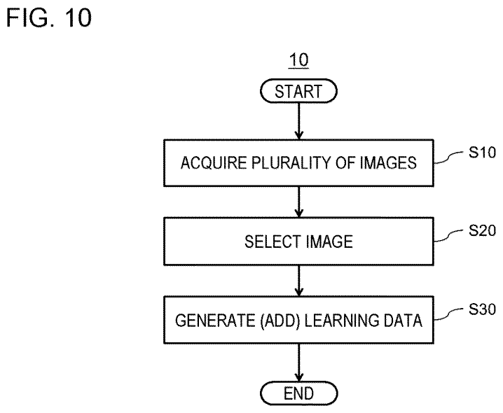

FIG. 10 is a flowchart illustrating an example of processing performed by the learning data generation apparatus 10.

First, the acquisition unit 110 acquires a plurality of images generated by the image capture apparatus 30 (Step S10). Next, the selection unit 120 selects an image to be used as learning data from among the images acquired in Step S10. An image to be selected includes at least an image to be used as negative data (Step S20). Then, the image processing unit 130 and the storage processing unit 140 perform processing for generating or adding learning data (Step S30).

Subsequently, the model generation unit 150 in the learning data generation apparatus 10 generates or updates a model at a predetermined timing. The communication unit 160 transmits the generated or updated model to the product count confirmation apparatus 20. For example, the timing at which the communication unit 160 transmits the model to the product count confirmation apparatus 20 is when the product count confirmation apparatus 20 is not performing the product registration processing.

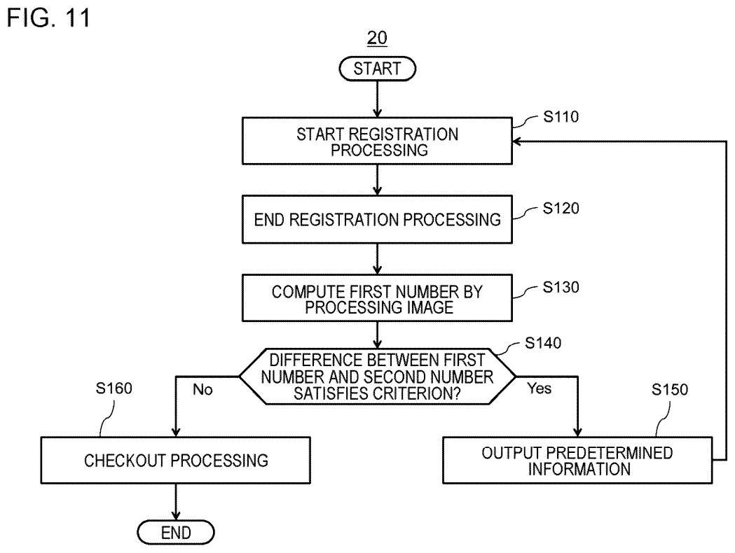

FIG. 11 is a flowchart illustrating an example of processing performed by the product count confirmation apparatus 20. A customer brings a product to be purchased to the product count confirmation apparatus 20 and subsequently causes the ancillary equipment 60 of the product count confirmation apparatus 20 to read the code of the product by operating the ancillary equipment 60.

The registration processing unit 230 in the product count confirmation apparatus 20 performs the registration processing of a product being a checkout target by using the readout result made by the ancillary equipment 60 so as to generate registration information (Step S110). When the registration processing ends (Step S120), the computation unit 210 in the product count confirmation apparatus 20 computes a first number by processing an image generated by the image capture apparatus 30 during the registration processing described above (Step S130).

Then, the output unit 220 determines a second number by using the registration information generated by the registration processing unit 230. When the difference between the second number and the first number satisfies the criterion, in other words, when there is a possibility that the registration information is incorrect (Step S140: Yes), the output unit 220 outputs the predetermined information (Step S150), and the process returns to Step S110.

On the other hand, when the difference between the second number and the first number does not satisfy the criterion, in other words, when the registration information is estimated to be correct (Step S140: No), the checkout processing unit 240 performs the checkout processing (Step S160).

Note that in Step S150, the output unit 220 may further output the predetermined information to a terminal operated by a seller of the product, such as a terminal operated by a clerk in the store.

As described above, the product count confirmation apparatus 20 according to the present example embodiment uses a model when computing a first number indicating the number of products by processing an image. At least part of learning data used for generating the model is generated by the learning data generation apparatus 10. The learning data generation apparatus 10 includes an image satisfying the predetermined condition into the learning data as negative data not including a target product. Accordingly, the computation precision of the first number by the model is high.

Then, the product count confirmation apparatus 20 performs the predetermined output when the difference between the first number and a second number being the number of target products registered in the product count confirmation apparatus 20 does not satisfy the criterion. Therefore, an administrator of the product count confirmation apparatus 20 or the customer thereon can recognize the possibility of a product not being accurately registered.

While the example embodiments of the present invention have been described above with reference to the drawings, the example embodiments are exemplifications of the present invention, and various configurations other than those described above may also be employed.

Further, while a plurality of steps (processing) are described in a sequential order in each of a plurality of flowcharts used in the aforementioned description, the execution order of steps executed in each example embodiment is not limited to the order of description. The order of the illustrated steps may be modified without affecting the contents in each example embodiment. Further, the aforementioned example embodiments may be combined without contradicting each other.

The whole or part of the example embodiments disclosed above may also be described as, but not limited to, the following supplementary notes.
1. A learning data generation apparatus that generates at least part of learning data for generating a model, in which
   the model computes a number of one or more target products being targets of checkout and being included in an image generated by an image capture unit that has an image capture range including a region where the target products are placed,
   the learning data generation apparatus including:
      an acquisition unit that acquires a plurality of images generated by the image capture unit: and
      a selection unit that selects an image satisfying one or more predetermined conditions out of the plurality of images in order to include the image into at least part of the learning data as negative data not including the target product.
2. The learning data generation apparatus according to supplementary note 1, in which
   at least one of the predetermined conditions is that a difference between the image and a reference image satisfies a first criterion.
3. The learning data generation apparatus according to supplementary note 1 or 2, in which
   at least one of the predetermined conditions is that a state of a product registration apparatus that performs registration processing of the target product satisfies one or more second criteria at a generation timing of the image.
4. The learning data generation apparatus according to supplementary note 3, in which
   at least one of the second criteria is that the product registration apparatus is not performing the registration processing.
5. The learning data generation apparatus according to supplementary note 3 or 4, in which
   at least one of the second criteria is that the product registration apparatus is in a standby mode and is turned off.
6. The learning data generation apparatus according to any one of supplementary notes 1 to 5, in which
   at least one of the predetermined conditions is that a generation timing of the image is a predetermined date and time.
7. The learning data generation apparatus according to any one of supplementary notes 1 to 6, in which
   at least one of the predetermined conditions is that the image includes a specific object.
8. The learning data generation apparatus according to supplementary note 7, in which
   the specific object indicates that a product registration apparatus that performs registration processing of the target product cannot be used.
9. The learning data generation apparatus according to any one of supplementary notes 1 to 8, in which
   at least one of the predetermined conditions is that no person exists in a predetermined region at a generation timing of the image.
10. The learning data generation apparatus according to supplementary note 9, in which
   the predetermined region includes the image capture range.
11. The learning data generation apparatus according to any one of supplementary notes 1 to 10, further including:
   an image processing unit that performs object detection processing on the image being the negative data: and
   a storage processing unit that stores the image on which the object detection processing is performed into a storage unit as at least part of the learning data, the image being tied to data indicating that a product is not included.
12. The learning data generation apparatus according to supplementary note 11, in which
   the image processing unit performs the object detection processing by using an algorithm for computing a number of the target products.
13. The learning data generation apparatus according to supplementary note 11 or 12, in which
   the image processing unit performs the object detection processing on a predetermined part in the image.
14. The learning data generation apparatus according to any one of supplementary notes 1 to 13, further including
   a model generation unit that generates the model by using the learning data.
15. A product count confirmation apparatus used with the learning data generation apparatus according to any one of supplementary notes 1 to 14, the product count confirmation apparatus including:
   a computation unit that, by using the model generated by using the learning data, computes a first number being a number of the target products by processing the image captured by the image capture unit when a customer uses a product registration apparatus that performs registration processing of the target product: and
   an output unit that outputs predetermined information when a difference between a second number being a number of the target products registered in the product registration apparatus and the first number satisfies a criterion.
16. A learning data generation method performed by a computer that generates at least part of learning data for generating a model, in which
   the model computes a number of one or more target products being targets of checkout and being included in an image generated by an image capture unit that has an image capture range including a region where the target products are placed,
   the learning data generation method including, by the computer:
      acquiring a plurality of images generated by the image capture unit: and
      selecting an image satisfying one or more predetermined conditions out of the plurality of images in order to include the image into at least part of the learning data as negative data not including the target product.
17. The learning data generation method according to supplementary note 16, in which
   at least one of the predetermined conditions is that a difference between the image and a reference image satisfies a first criterion.
18. The learning data generation method according to supplementary note 16 or 17, in which
   at least one of the predetermined conditions is that a state of a product registration apparatus that performs registration processing of the target product satisfies one or more second criteria at a generation timing of the image.
19. The learning data generation method according to supplementary note 18, in which
   at least one of the second criteria is that the product registration apparatus is not performing the registration processing.
20. The learning data generation method according to supplementary note 18 or 19, in which
   at least one of the second criteria is that the product registration apparatus is in a standby mode and is turned off.
21. The learning data generation method according to any one of supplementary notes 16 to 20, in which
   at least one of the predetermined conditions is that a generation timing of the image is a predetermined date and time.
22. The learning data generation method according to any one of supplementary notes 16 to 21, in which
   at least one of the predetermined conditions is that the image includes a specific object.
23. The learning data generation method according to supplementary note 22, in which
   the specific object indicates that a product registration apparatus that performs registration processing of the target product cannot be used.
24. The learning data generation method according to any one of supplementary notes 16 to 23, in which
   at least one of the predetermined conditions is that no person exists in a predetermined region at a generation timing of the image.
25. The learning data generation method according to supplementary note 24, in which
   the predetermined region includes the image capture range.
26. The learning data generation method according to any one of supplementary notes 16 to 25, further including, by the computer:
   performing object detection processing on the image being the negative data: and
   storing the image on which the object detection processing is performed into a storage unit as at least part of the learning data, the image being tied to data indicating that a product is not included.
27. The learning data generation method according to supplementary note 26, in which, by the computer,
   the object detection processing is performed by using an algorithm for computing a number of the target products.
28. The learning data generation method according to supplementary note 26 or 27, in which, by the computer,
   the object detection processing is performed on a predetermined part in the image.
29. The learning data generation method according to any one of supplementary notes 16 to 28, further including, by the computer,
   generating the model by using the learning data.
30. A product count confirmation method including, by a computer used with the learning data generation apparatus according to any one of supplementary notes 1 to 14:
   by using the model generated by using the learning data, computing a first number being a number of the target products by processing the image captured by the image capture unit when a customer uses a product registration apparatus that performs registration processing of the target product; and
   outputting predetermined information when a difference between a second number being a number of the target products registered in the product registration apparatus and the first number satisfies a criterion.
31. A storage medium on which a program causing a computer to generate at least part of learning data for generating a model is recorded, in which
   the model computes a number of one or more target products being targets of checkout and being included in an image generated by an image capture unit that has an image capture range including a region where the target products are placed,
   the program causing the computer to execute:
      an acquisition function of acquiring a plurality of images generated by the image capture unit: and
      a selection function of selecting an image satisfying one or more predetermined conditions out of the plurality of images in order to include the image into at least part of the learning data as negative data not including the target product.
32. The storage medium according to supplementary note 31, in which
   at least one of the predetermined conditions is that a difference between the image and a reference image satisfies a first criterion.
33. The storage medium according to supplementary note 31 or 32, in which
   at least one of the predetermined conditions is that a state of the product registration apparatus satisfies one or more second criteria at a generation timing of the image.
34. The storage medium according to supplementary note 33, in which
   at least one of the second criteria is that the product registration apparatus is not performing the registration processing.
35. The storage medium according to supplementary note 33 or 34, in which
   at least one of the second criteria is that the product registration apparatus is in a standby mode and is turned off.
36. The storage medium according to any one of supplementary notes 31 to 35, in which
   at least one of the predetermined conditions is that a generation timing of the image is a predetermined date and time.
37. The storage medium according to any one of supplementary notes 31 to 36, in which
   at least one of the predetermined conditions is that the image includes a specific object.
38. The storage medium according to supplementary note 37, in which
   the specific object indicates that a product registration apparatus that performs registration processing of the target product cannot be used.
39. The storage medium according to any one of supplementary notes 31 to 38, in which
   at least one of the predetermined conditions is that no person exists in a predetermined region at a generation timing of the image.
40. The storage medium according to supplementary note 39, in which
   the predetermined region includes the image capture range.
41. The storage medium according to any one of supplementary notes 31 to 40,
   the program further causing the computer to execute:
   an image processing function of performing object detection processing on the image being the negative data: and
   a storage processing function of storing the image on which the object detection processing is performed into a storage unit as at least part of the learning data, the image being tied to data indicating that a product is not included.
42. The storage medium according to supplementary note 41, in which
   the image processing function performs the object detection processing by using an algorithm for computing a number of the target products.
43. The storage medium according to supplementary note 41 or 42, in which
   the image processing function performs the object detection processing on a predetermined part in the image.
44. The storage medium according to any one of supplementary notes 31 to 43,
   the program further causing the computer to execute a model generation function of generating the model by using the learning data.
45. A storage medium on which a program used by a computer used with the learning data generation apparatus according to any one of supplementary notes 1 to 14 is recorded, the program causing the computer to execute:
   a computation function of, by using the model generated by using the learning data, computing a first number being a number of the target products by processing the image captured by the image capture unit when a customer uses a product registration apparatus that performs registration processing of the target product; and
an output function of outputting predetermined information when a difference between a second number being a number of the target products registered in the product registration apparatus and the first number satisfies a criterion.
46. The program according to any one of supplementary notes 41 to 44.
47. The program according to supplementary note 45.

### REFERENCE SIGNS LIST

10 Learning data generation apparatus
20 Product count confirmation apparatus
30 Image capture apparatus
40 Product information storage unit
50 Table
60 Ancillary equipment
70 Object
110 Acquisition unit
120 Selection unit
130 Image processing unit
140 Storage processing unit
150 Model generation unit
160 Communication unit
170 Learning data storage unit 170
210 Computation unit
220 Output unit
230 Registration processing unit
240 Checkout processing unit
250 Communication unit
260 Model storage unit

What is claimed is:

1. A learning data generation apparatus that generates at least part of learning data for generating a model, wherein
the model computes a number of one or more target products being targets of checkout and being included in an image generated by a camera that has an image capture range including a region where the target products are placed,
the learning data generation apparatus comprising:
at least one memory storing instructions; and
at least one processor executing the instructions to perform operations comprising:
acquiring a plurality of images generated by the camera; and
selecting an image satisfying one or more predetermined conditions out of the plurality of images in order to include the image into at least part of the learning data as negative data not including the target product.

2. The learning data generation apparatus according to claim 1, wherein
at least one of the predetermined conditions is that a difference between the image and a reference image satisfies a first criterion.

3. The learning data generation apparatus according to claim 1, wherein
at least one of the predetermined conditions is that a state of a product registration apparatus that performs registration processing of the target product satisfies one or more second criteria at a generation timing of the image.

4. The learning data generation apparatus according to claim 3, wherein
at least one of the second criteria is that the product registration apparatus is not performing the registration processing.

5. The learning data generation apparatus according to claim 3, wherein
at least one of the second criteria is that the product registration apparatus is in a standby mode and is turned off.

6. The learning data generation apparatus according to claim 1, wherein
at least one of the predetermined conditions is that a generation timing of the image is a predetermined date and time.

7. The learning data generation apparatus according to claim 1, wherein
at least one of the predetermined conditions is that the image includes a specific object.

8. The learning data generation apparatus according to claim 7, wherein
the specific object indicates that a product registration apparatus that performs registration processing of the target product cannot be used.

9. The learning data generation apparatus according to claim 1, wherein
at least one of the predetermined conditions is that no person exists in a predetermined region at a generation timing of the image.

10. The learning data generation apparatus according to claim 9, wherein
the predetermined region includes the image capture range.

11. The learning data generation apparatus according to claim 1, wherein the operations further comprise:
performing object detection processing on the image being the negative data; and
storing the image on which the object detection processing is performed into a storage as at least part of the learning data, the image being tied to data indicating that a product is not included.

12. The learning data generation apparatus according to claim 11, wherein the operations further comprise
performing the object detection processing by using an algorithm for computing a number of the target products.

13. The learning data generation apparatus according to claim 11, wherein the operations further comprise
performing the object detection processing on a predetermined part in the image.

14. The learning data generation apparatus according to claim 1, wherein the operations further comprise
generating the model by using the learning data.

15. A product count confirmation apparatus used with the learning data generation apparatus according to claim 1, the product count confirmation apparatus comprising:
at least one memory storing instructions; and
at least one processor executing the instructions to perform operations comprising:
by using the model generated by using the learning data, computing a first number being a number of the target products by processing the image captured by the camera when a customer uses a product registration apparatus that performs registration processing of the target product; and
outputting predetermined information when a difference between a second number being a number of the target products registered in the product registration apparatus and the first number satisfies a criterion.

16. A learning data generation method performed by a computer that generates at least part of learning data for generating a model, wherein
the model computes a number of one or more target products being targets of checkout and being included in an image generated by a camera that has an image capture range including a region where the target products are placed,
the learning data generation method comprising, by the computer:
acquiring a plurality of images generated by the camera; and
selecting an image satisfying one or more predetermined conditions out of the plurality of images in order to include the image into at least part of the learning data as negative data not including the target product.

17. A product count confirmation method comprising, by a computer used with the learning data generation apparatus according to claim 1:
by using the model generated by using the learning data, computing a first number being a number of the target products by processing the image captured by the camera when a customer uses a product registration apparatus that performs registration processing of the target product; and
outputting predetermined information when a difference between a second number being a number of the target products registered in the product registration apparatus and the first number satisfies a criterion.

18. A non-transitory computer-readable storage medium on which a program causing a computer to generate at least part of learning data for generating a model is recorded, wherein
the model computes a number of one or more target products being targets of checkout and being included in an image generated by a camera that has an image capture range including a region where the target products are placed,
the program causing the computer to perform operations comprising:
acquiring a plurality of images generated by the camera; and
selecting an image satisfying one or more predetermined conditions out of the plurality of images in order to include the image into at least part of the learning data as negative data not including the target product.

19. A non-transitory computer-readable storage medium on which a program used by a computer used with the learning data generation apparatus according to claim 1 is recorded, the program causing the computer to perform operations comprising:
by using the model generated by using the learning data, computing a first number being a number of the target products by processing the image captured by the camera when a customer uses a product registration apparatus that performs registration processing of the target product; and
outputting predetermined information when a difference between a second number being a number of the target products registered in the product registration apparatus and the first number satisfies a criterion.
